(19) United States
(12) Patent Application Publication
(10) Pub. No.: US 2009/0135306 A1
(43) Pub. Date: May 28, 2009

(54) RECEIVER HAVING A TUNING CAPACITANCE

(75) Inventors: Kui Y. Lim, Singapore (SG); Joe K. K. Leong, Singapore (SG)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/910,453

(22) PCT Filed: Mar. 16, 2006
(86) PCT No.: PCT/IB2006/050821

§ 371 Date: Sep. 26, 2008

(30) Foreign Application Priority Data
Mar. 29, 2005 (EP) 05102464.4

(51) Int. Cl. H04N 5/46

(52) U.S. Cl. 348/729; 348/E05.114

(57) ABSTRACT

A receiver has a tuning capacitance that comprises two capacitive branches (V1-C1, C2-V2) coupled in parallel between a pair of capacitance nodes (N1, N2). One capacitive branch (V1-C1) comprises a varicap diode (V1) having an anode that is coupled to one capacitance node (N1) and a cathode that is coupled to the other capacitance node (N2). The other capacitive branch (C2-V2) comprises a varicap diode (V2) having a cathode that is coupled to the one capacitance node (N1) and an anode that is coupled to the other capacitance node (N2).

### FIELD OF THE INVENTION

An aspect of the invention relates to a receiver that has a tuning capacitance. The receiver may be, for example, a television receiver can be tuned to any particular television channel in a radiofrequency spectrum that comprises numerous different television channels. Another aspect of the invention relates to an information rendering system, such as, for example, a video display system.

### DESCRIPTION OF PRIOR ART

Japanese patent abstract publication number 62-076914 describes an input filter circuit. The input circuit comprises two varactor diodes. The two varactor diodes are connected in series between a common point and a connecting point between two coils, which are connected in series between input and output terminals.

### SUMMARY OF THE INVENTION

According to an aspect of the invention, a receiver has a tuning capacitance that comprises two capacitive branches coupled in parallel between a pair of capacitance nodes. One capacitive branch comprises a varicap diode having an anode that is coupled to one capacitance node and a cathode that is coupled to the other capacitance node. The other capacitive branch comprises a varicap diode having a cathode that is coupled to the one capacitance node and an anode that is coupled to the other capacitance node.

The invention takes the following aspects into consideration. In many applications, a tuning capacitance is realized by means of one or more so-called varicap diodes. A varicap diode has a capacitance that varies as a function of a control voltage applied between a cathode and an anode of the varicap diode. Accordingly, the varicap diode is an electrically controllable capacitance, which is generally much more convenient than a mechanically controllable capacitance.

However, a varicap diode inherently has a nonlinear signal-handling characteristic. As a result, the varicap diode generates parasitic signals when one or more signals are applied to the varicap diode. These parasitic signals, which may be harmonic components of a signal or intermodulation products of various signals, may cause interference and degrade reception quality.

It is possible to implement a low-distortion tuning capacitance by means of varicap diodes in the following manner. Two varicap diodes are coupled in series. Preferably, the respective cathodes of the two varicap diodes are coupled to each other. The cathodes receive a tuning control voltage. The respective anodes of the two varicap diodes constitute a pair of capacitance nodes. The aforementioned prior-art comprises such a tuning-capacitance implementation.

The low-distortion tuning capacitance described hereinbefore provides a relatively small tuning capacitance. This is because the two varicap diodes are coupled in series. The low-distortion tuning capacitance will be approximately one half the capacitance of one or the other varicap diode, assuming that the varicap diodes are similar.

Consequently, a tunable circuit that comprises a low-distortion tuning capacitance as described hereinbefore, will need to have relatively large inductance for given tuning frequency. A relatively large inductance generally requires a relatively large coil. In principle, material of high permeability makes it possible to achieve a relatively large inductance with relatively small coil. However, such material is inherently nonlinear and may cause further parasitic signals.

In accordance with the aforementioned aspect of the invention, a tuning capacitance comprises two capacitive branches coupled in parallel between a pair of capacitance nodes. One capacitive branch comprises a varicap diode having an anode that is coupled to one capacitance node and a cathode that is coupled to the other capacitance node. The other capacitive branch comprises a varicap diode having a cathode that is coupled to the one capacitance node and an anode that is coupled to the other capacitance node.

In the tuning capacitance in accordance with the invention, a parasitic signal in the one capacitive branch, which is due to an even-order nonlinearity of the varicap diode therein, will be compensated for by a similar parasitic signal in the other capacitive branch. There is a parasitic-signal compensating effect. In addition, the tuning capacitance is relatively large. The tuning capacitance is the sum of the respective capacitances of the one and the other capacitive branch, each of which comprises a varicap diode. Consequently, it is possible to obtain a given tuning-frequency range with a relatively small inductance. For example, assuming the capacitive branches are similar, the inductance is approximately half the inductance that would be required if there were a single capacitive branch only. The invention thus allows a coil-size reduction. For those reasons, the invention allows a receiver of modest size, which, nevertheless, provides a relatively quality of reception.

These and other aspects of the invention will be described in greater detail hereinafter with reference to drawings.

### BRIEF DESCRIPTION OF THE DRAWINGS

FIG. 1 is a block diagram that illustrates a video display system, which comprises a tuner.

FIG. 2 is a circuit diagram that illustrates an input filter, which forms part of the tuner.

FIG. 3 is a circuit diagram that illustrates a band pass filter, which forms part of the tuner.

### DETAILED DESCRIPTION

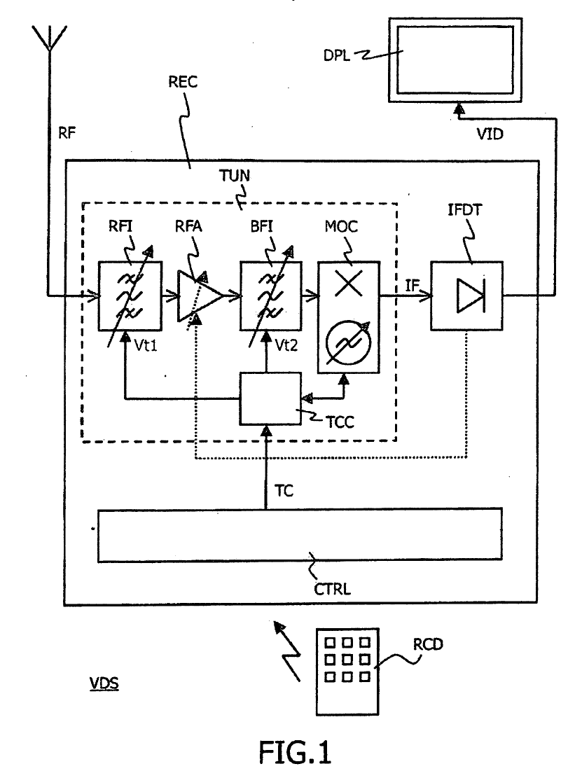

FIG. 1 illustrates a video-display system VDS. The video-display system VDS comprises a receiver REC and a display device DPL. The receiver REC derives a video signal VID from a desired channel in a radiofrequency spectrum RF, which the receiver REC receives. The display device DPL displays the video signal VID. A user can select the desired channel by means of, for example, a remote-control device RCD. The receiver REC may be in the form of, for example, a television set, a settop box, or a digital video recorder, or the like.

The receiver REC comprises a tuner TUN, a backend circuit IFDT, and a controller CTRL. The tuner TUN converts the radiofrequency spectrum RF into an intermediate frequency spectrum IF, which the backend circuit IFDT receives. The intermediate frequency spectrum IF comprises a frequency-shifted version of the desired channel. The tuner TUN carries out a frequency shift so that the frequency-shifted version of the desired channel is at a predefined intermediate frequency. The backend circuit IFDT derives the video signal from the frequency-shifted version of the desired channel within the intermediate frequency spectrum IF. To that end, the backend circuit IFDT may carry out various operations, such as, for example, band pass filtering, demodulation, and, in the case of digital signals, channel decoding, error correction, and baseband decoding.

The tuner TUN comprises an input filter RFI, an input amplifier RFA, a band-pass filter BFI, a mixer-oscillator circuit MOC, and a tuning-control circuit TCC. The input filter RFI suppresses signals that are outside a frequency band in which the desired channel lies. The input filter RFI further provides impedance matching between the input amplifier RFA and an electrical entity via which the tuner TUN receives the radiofrequency spectrum RF. The electrical entity may be, for example, an antenna or a cable network. The input amplifier RFA provides some amplification, which allows a satisfactory signal-to-noise ratio under weak signal conditions. The band-pass filter BFI suppresses signals that would otherwise cause interference in the intermediate frequency spectrum IF. The mixer-oscillator circuit MOC carries out the aforementioned frequency shift, which causes the frequency-shifted version of the desired channel to be at the predetermined intermediate frequency.

The receiver REC may tune to any channel within a frequency band. This tuning operates as follows. A user selects a particular channel, for example, by entering a program number on the remote-control device. In response, the controller CTRL applies a tuning command TC to the tuner TUN. The tuning-control circuit TCC controls the mixer-oscillator circuit MOC in accordance with the tuning command TC. More specifically, the tuning-control circuit TCC causes the mixer-oscillator circuit MOC to carry out a frequency shift corresponding with the channel that the user has selected. The frequency shift is so that the tuner TUN provides a frequency-shifted version of the channel in the intermediate frequency spectrum IF at the predefined intermediate frequency.

The tuning of the receiver REC also involves tuning the input filter RFI and the band-pass filter BFI in the tuner TUN. The receiver REC has one or more “weak spots” in the radiofrequency spectrum RF. A signal in such a weak spot, which is a frequency interval, will cause interference in the intermediate frequency spectrum IF. The input filter RFI and the band-pass filter BFI need to provide sufficient attenuation in the weak spots in the radiofrequency spectrum RF. The location of a weak spot in the radiofrequency spectrum RF depends on the channel to which the receiver REC is tuned. That is, tuning the receiver REC from one channel to another channel, will shift the weak spot in the radiofrequency spectrum RF. Consequently, the input filter RFI and the band-pass filter BFI are preferably tuned so that these filters provide sufficient attenuation in the weak spots, irrespective of the channel to which the receiver REC is tuned.

The input filter RFI and the band-pass filter BFI are tunable by means of tuning voltages Vt1 and Vt2, respectively, which the tuning-control circuit TCC provides in response to the tuning command TC. The input filter RFI and the band-pass filter BFI typically comprise voltage-controllable capacitances, which receive the tuning voltages Vt1 and Vt2, respectively. These voltage controllable capacitances allow tuning of the input filter RFI and the band-pass filter BFI.

However, a voltage-controllable capacitance generally has a certain nonlinearity. For example, a varicap diode, which is a widely used voltage-controllable capacitance, provides a capacitance whose value varies to a certain extent as a function of a signal that is applied to the varicap diode. Such nonlinearity generates parasitic signal components, which may cause interference. The interference will be relatively strong under large-signal conditions. The interference will also be relatively strong when there are relatively many different medium-strength signals, which is typically the case in cable-network reception. In those conditions, the input filter RFI and the band-pass filter BFI, which are illustrated in FIG. 1, should prevent interference rather than generate interference.

There is another important aspect that relates to the input filter RFI and the band-pass filter BFI: the physical size of the tuner TUN. The input filter RFI and the band-pass filter BFI generally comprise one or more inductances in the form of coils. A coil occupies a certain space. The higher the inductance is, the more voluminous the coil needs to be for a given magnetic permeability. In principle, it is possible to reduce the size of a coil by using a material which has a relatively high magnetic permeability. However, such a material generally has a certain nonlinearity, which causes the inductance to be nonlinear, similar to the voltage controllable capacitance. Such additional nonlinearity may not be acceptable.

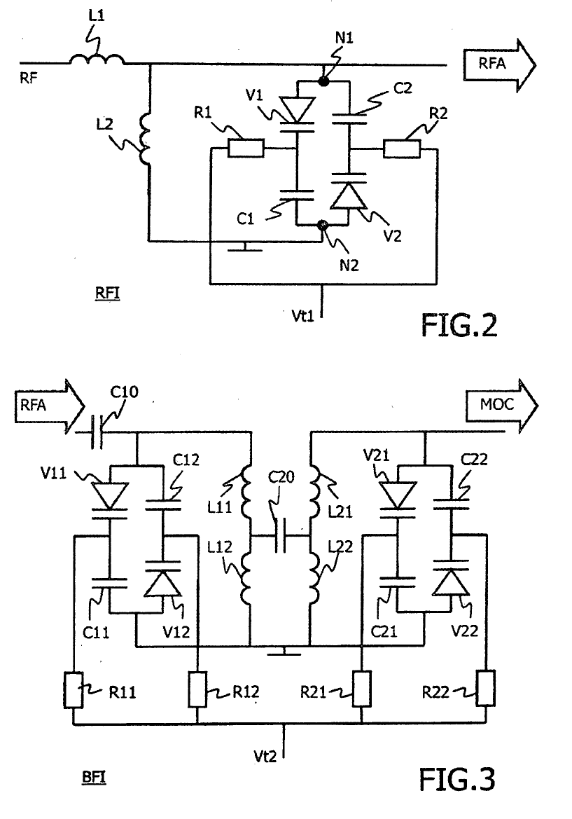

FIG. 2 illustrates an implementation of the input filter RFI that prevents interference and that can be of relatively small size. The input filter RFI comprises two inductances L1, L2, two varicap diodes V1, V2, two capacitances C1, C2, and two resistances R1, R2.

The two varicap diodes V1, V2 and the two capacitances C1, C2 form a tuning capacitance between capacitance nodes N1, N2. This tuning capacitance is coupled in parallel with inductance L2 and forms a parallel LC circuit. The tuning capacitance comprises two capacitive branches. Varicap diode V1 and capacitance C1 constitute one capacitive branch. Varicap diode V2 and capacitance C2 constitute another capacitive branch.

Varicap diode V1 has a cathode that receives tuning voltage Vt1 via resistance R1, and an anode that is coupled to capacitance node N1. The cathode of varicap diode V1 is coupled to capacitance node N2 via capacitance C1.

Varicap diode V2 has a cathode that receives tuning voltage Vt1 via resistance R2, and an anode that is coupled to capacitance node N2. The cathode of varicap diode V1 is coupled to capacitance node N2 via capacitance C2.

Capacitances C1, C2 provide direct-current decoupling. The respective values of capacitances C1, C2 are preferably relatively high with regard to the respective maximum capacitance values that varicap diodes V1, V2 can provide. In that case, capacitances C1, C2 can be considered as short circuits at the radiofrequencies of interest. The tuning capacitance will be substantially equal to the sum of respective capacitance values that varicap diodes V1, V2 provide. In contradistinction, the tuning capacitance will be lower if the respective values of capacitances C1, C2 have the same order of magnitude as the respective maximum capacitance values that varicap diodes V1, V2 can provide. Moreover, the tuning capacitance will have a smaller tuning range in that case.

Inductance L2 forms a direct-current short circuit. Consequently, capacitance node N1 is coupled to signal ground from a direct-current point-of-view. Capacitance node N2 is directly coupled to signal ground. Consequently, tuning voltage Vt1 is present between the cathode and the anode of varicap diode V1 and between the cathode and the anode of varicap diode V2. As a result, the two varicap diodes V1, V2 will provide substantially identical capacitance values, assuming that the two varicap diodes V1, V2 are identical and perfectly match. In practice, varicap diodes V1, V2 will provide slightly different capacitance values due to varicap-production spread.

Let it be assumed that a radiofrequency signal is present between the capacitance nodes N1, N2. Let it further be assumed that capacitances C1, C2 can indeed be considered as short circuits at the radiofrequencies of interest. The radiofrequency signal will be present between the respective cathodes and anodes of the two varicap diodes V1, V2. The radiofrequency signal that is present between the cathode and the anode of varicap diode V1 is of opposite polarity with respect to the radiofrequency signal that is present between the cathode and the anode of varicap diode V2. There is a signal sign inversion between the two varicap diodes.

Each of the two varicap diodes V1, V2 produces parasitic signal components because the two varicap diodes V1, V2 have a certain nonlinearity, which has been mentioned hereinbefore. A parasitic signal component that varicap diode V1 produces, which results from even-order nonlinearity, will be of opposite sign with regard to a similar parasitic signal component that varicap V2 produces. As a result, the respective parasitic signal components substantially cancel out. This interference-compensating effect is due to the signal sign inversion mentioned hereinbefore, which inherently occurs in the implementation that FIG. 2 illustrates.

The implementation, which FIG. 2 illustrates, has another advantageous feature. The tuning capacitance between the capacitance nodes N1, N2 is approximately equal to the sum of the respective capacitances that varicap diodes V1, V2 provide. That is, the tuning capacitance is relatively large. This allows inductance L2 to have a relatively small value for a given tuning frequency. The same applies to inductance L1. Accordingly, the two inductances L1, L2 can be implemented by means of relatively small coils. This allows the tuner TUN, which FIG. 1 illustrates, to be relatively small.

FIG. 3 illustrates an implementation of the band-pass filter BFI that is relatively linear and that can be of small size. The band-pass filter BFI comprises six capacitances C10, C11, C12, C20, C21, C22, four inductances L11, L12, L21, L22, four varicap diodes V11, V12, V21, V22, and four resistances R11, R12, R21, R22. Varicap diodes V11, V12 and capacitances C11, C12 form a tuning capacitance, which is similar to the tuning capacitance in the input filter RFI described hereinbefore. The tuning capacitance is coupled in parallel with inductances L11, L12. Varicap diodes V21, V22 and capacitances C21, C22 form a further tuning capacitance. This further tuning capacitance is coupled in parallel with inductances L21, L22.

The implementation of the band-pass filter BFI, which FIG. 3 illustrates, has the same advantageous features as the implementation of the input filter RFI, which FIG. 2 illustrates. That is, the tuning capacitances are configured so that there is an interference-compensating effect. Furthermore, the tuning capacitances are relatively large, which allows the four inductances L11, L12, L21, L22 to be implemented by means of relatively small coils.

### CONCLUDING REMARKS

The detailed description hereinbefore with reference to the drawings illustrates the following characteristics, which are cited in claim 1. A receiver (REC) has a tuning capacitance that comprises two capacitive branches (V1-C1, C2-V2) coupled in parallel between a pair of capacitance nodes (N1, N2). One capacitive branch (V1-C1) comprises a varicap diode (V1) having an anode that is coupled to one capacitance node (N1) and a cathode that is coupled to the other capacitance node (N2). The other capacitive branch (C2-V2) comprises a varicap diode (V2) having a cathode that is coupled to the one capacitance node (N1) and an anode that is coupled to the other capacitance node (N2).

The aforementioned characteristics can be implemented in numerous different manners. In order to illustrate this, some alternatives are briefly indicated.

A varicap diode need not necessarily have an anode which is directly coupled to signal ground as in FIGS. 2 and 3. For example, the anode may be coupled to a biasing voltage via an impedance that constitutes an open circuit for the radiofrequencies of interest. In addition, the node may be coupled to signal ground via a decoupling capacitor, which constitutes a short circuit at the radiofrequencies of interest. It is also possible to apply a control voltage to the anode instead of the cathode, which can be coupled to receive a fixed biasing voltage.

The term varicap diode should be broadly interpreted so as to include any type of controllable capacitance having two nodes of opposite polarity.

There are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions. Nor does it exclude that an assembly of items of hardware or software or both carry out a function.

The remarks made herein before demonstrate that the detailed description with reference to the drawings, illustrate rather than limit the invention. There are numerous alternatives, which fall within the scope of the appended claims. Any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. A receiver (REC) having a tuning capacitance comprising two capacitive branches coupled in parallel between a pair of capacitance nodes, one capacitive branch comprising a varicap diode having an anode that is coupled to one capacitance node and a cathode that is coupled to the other capacitance node, the other capacitive branch comprising a varicap diode iamb having a cathode that is coupled to the one capacitance node and an anode that is coupled to the other capacitance node.

2. A receiver as claimed in claim 1, each capacitive branch comprising a fixed capacitance coupled in series with the varicap diode.

3. A receiver as claimed in claim 1, the one capacitance node being coupled to signal ground via a direct-current-transferring path, the other capacitance node being directly coupled to signal ground.

4. A receiver as claimed in claim 3, the direct-current-transferring path comprising an inductance, which forms a resonance circuit in combination with the tuning capacitance.

5. A video display system (VDS) comprising a receiver (REC) as claimed in claim 1 arranged to retrieve an information (VID) from a radiofrequency signal (RF), and an information rendering device (DPL) for rendering the information (VID) retrieved.
